(19) United States
(12) Patent Application Publication
(10) Pub. No.: US 2004/0075542 A1
(43) Pub. Date: Apr. 22, 2004

(54) Covering apparatus for remote transmitters

(76) Inventor: Sara J. Glasscock, Jennings, MO (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/065,445

(22) Filed: Oct. 18, 2002

(51) Int. Cl. B60R 25/10

(52) U.S. Cl. 340/426.36; 340/693.5; 340/5.7

(57) ABSTRACT

A transmitter assembly includes a sheath, a closing mechanism, and a transmitter for remote activation of a receiver. The transmitter includes at least one actuator and the sheath is configured to facilitate non-actuation of the transmitter. The closing mechanism is connected to the sheath and is configured to maintain the sheath adjacent the at least one actuator when the closing mechanism is activated.

### BACKGROUND OF INVENTION

This invention relates generally to transmitters and, more particularly, to covering apparatus for remote transmitters.

A transmitter transmits a coded signal for reception by a receiver when the transmitter is actuated within a pre-determined distance from the receiver. Known transmitters typically include at least one actuator button, such that the transmitter transmits a signal to the receiver when the actuator button is depressed. For example, a remote keyless entry system for a motor vehicle includes a receiver adapted to be fixedly mounted on, or within, a motor vehicle, and a transmitter. Depressing a lock actuator button on the remote keyless entry system transmitter transmits a coded signal to the receiver, which causes the doors of the motor vehicle to be locked. Likewise, depressing an unlock actuator button on the transmitter causes the vehicle doors to be unlocked.

At least some known transmitters are portable electronic devices sized to be carried in a pocket or attached to a key fob. The actuator buttons may be easily depressed. As such, operators may actuate such transmitters inadvertently, thereby creating such inconveniences as leaving a motor vehicle unlocked or activating an alarm system unintentionally.

### SUMMARY OF INVENTION

In one aspect, a transmitter assembly is provided that comprises a transmitter including at least one actuator for remote activation of a receiver; a sheath configured to facilitate non-actuation of the transmitter; and a closing mechanism connected to the sheath. The closing mechanism is configured to maintain the sheath adjacent the at least one actuator when the closing mechanism is activated.

### BRIEF DESCRIPTION OF DRAWINGS

FIG. 1 illustrates a known transmitter.

FIG. 2 is an exemplary embodiment of a transmitter assembly including the transmitter illustrated in FIG. 1 and a sheath.

FIG. 3 is another exemplary transmitter assembly including the transmitter illustrated in FIG. 1 and an alternative transmitter sheath.

FIG. 4 is a further exemplary transmitter assembly including the transmitter illustrated in FIG. 1 and a further alternative transmitter sheath.

### DETAILED DESCRIPTION

Exemplary embodiments of covering apparatus, e.g., sheaths, for remote transmitters are described below. The covering apparatus are configured to fit with new remote transmitters and existing remote transmitters, as well as be coupled to, be integral with, and form a part of, new remote transmitters. The apparatus are not limited to the specific embodiments described herein. In addition, components from each embodiment can be practiced independent and separate from other components described herein. Also, each component can be used in combination with other components.

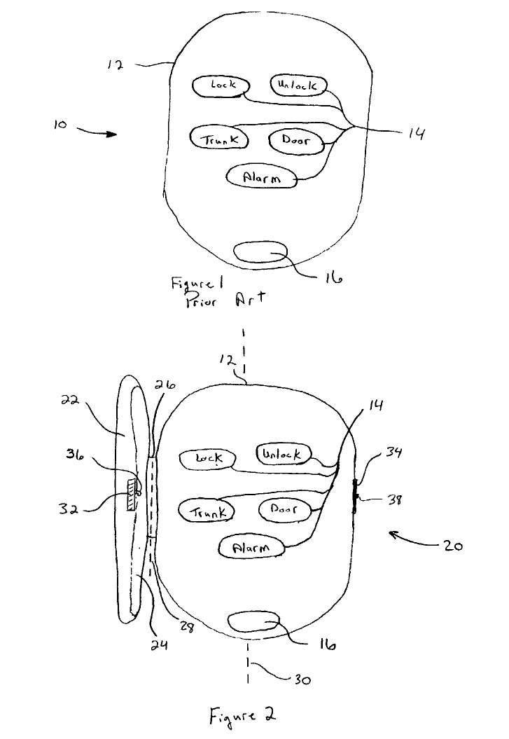

FIG. 1 illustrates a known transmitter 10 that includes a housing 12 and actuator buttons 14. Transmitter 10 further includes an aperture 1 6 for attaching transmitter 10 to a key fob (not shown) to enhance portability. In one embodiment, transmitter 10 is a remote control transmitter or a remote keyless entry transmitter, such that actuating transmitter 10, for example, by depressing at least one actuator button 14, results in transmission of a coded signal for reception by a receiver (not shown). In the embodiment shown, transmitter 10 is configured only to transmit, and not to receive, signals.

FIG. 2 illustrates an exemplary embodiment of a transmitter assembly 20 that includes transmitter 10 coupled to a covering apparatus, e.g., a sheath 22. Elements shown in FIG. 2 that are identical to elements shown in FIG. 1 utilize the same reference numerals used in FIG. 1. Sheath 22 is movable between a first, closed position (not shown) and a second, open position. Sheath 22 is made of a material effective to prevent actuation of transmitter 10 when sheath 22 is in the first position. The first position facilitates non-actuation of transmitter 10 by positioning sheath 22 such that an inner surface 24 of sheath 22 is adjacent actuator buttons 14. The second position, shown in FIG. 2, facilitates actuation of transmitter 10 by positioning sheath 22 sufficiently away from actuator buttons 14 to allow an operator to actuate transmitter 10.

Sheath 22 is connected to housing 12 with a connecting member 26. In the embodiment shown, connecting member 26 is a hinge member that connects sheath 22 to housing 12. The hinge member, as shown, is a living hinge, e.g., a hinge unitary with sheath 22 and housing 12. In another embodiment, the hinge member includes a pin (not shown) that connects two separate pieces of material together. In a further embodiment, the hinge member is a joining location for two separate pieces of material that snap-fit together with friction fit members and assemble in a rotational relationship. Alternatively, connecting member 26 is any type of member configured to pivotably connect sheath 22 with housing 12. In one embodiment, one of housing 12 and sheath 22 include a seal (not shown) that facilitates the prevention of liquids from contacting actuator button 14 when sheath 22 is in the first, closed position. The seal is fabricated from a suitable sealing material as is well known in the art.

In the embodiment shown, connecting member 26 includes a pivot axis 28 substantially parallel to a longitudinal axis 30 of housing 12. Alternatively, connecting member 26 includes a pivot axis (not shown) that is substantially perpendicular to housing longitudinal axis 30.

Sheath 22 also includes a locking member 32 that interfits with a locking receptacle 34 located on housing 12. Alternatively, locking member 32 extends from housing 12 and sheath 22 includes locking receptacle 34. In the embodiment shown in FIG. 2, locking member 32 includes a latch 36 that interlocks with a pin, or other member 38, to maintain sheath 22 in the closed position with respect to housing 12. Alternatively, any type of interlocking mechanism configured to maintain sheath 30 in the closed position can be used with transmitter 20. In one embodiment, locking member 32 is a biasing mechanism (not shown) that is contained, at least partially, within, or attached to, connecting member 26. For example, the biasing mechanism may be a spring contained within connecting member 26 and biasing sheath 22 in the closed position. Alternatively, locking member 32 is a gravity assisted locking member.

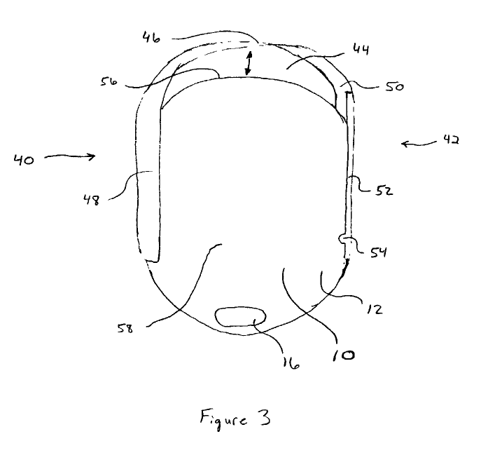

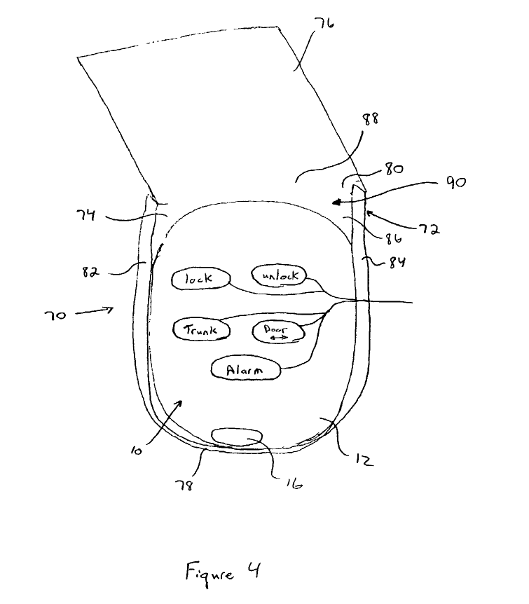

FIG. 3 illustrates an alternative transmitter assembly 40 including a transmitter, such as transmitter 10, and a covering apparatus 42, e.g., a sheath, that is utilized with transmitter 10. Elements shown in FIG. 3 that are identical to elements shown in FIG. 1 utilize the same reference numerals used in FIG. 1. Sheath 42 includes a front 44, a top 46, and a pair of sides 48 and 50. Each side 48 and 50 includes a sliding rail 52 and a locking mechanism 54. Sliding rails 52 and locking mechanism 54 form a friction fit with transmitter housing 12 to maintain sheath 42 in a first, closed, position with respect to housing 12. Sheath 42 is slidably coupled to transmitter 10, such that sheath 42 is movable from the first closed position to a second, open, position (not shown). In an alternative embodiment, sheath 42 remains pivotally coupled to transmitter 10. In the first position, a top 56 of transmitter 10 is maintained adjacent sheath top 46. In addition, a front portion (not shown) of housing 12 is contained at least partially within sheath 42 such that at least one actuator button is maintained adjacent front 44 of sheath 42. More specifically, when sheath 42 is in the first closed position, inadvertent actuation of the actuator button is facilitated to be prevented. In the exemplary embodiment, locking mechanism 54 contacts a portion of housing 12 to maintain sheath 42 in the first position. In a further embodiment, one of housing 12 and sheath 22 include a seal (not shown) that facilitates the prevention of liquids from contacting actuator button 14 when sheath 22 is in the first, closed position. The seal is fabricated from a suitable sealing material as is well known in the art.

As illustrated in FIG. 3, a back 58 of transmitter 10 is mostly exposed and uncovered by sheath 42. In an alternative embodiment, sheath sides 48 and 50 extend from a back (not shown) such that a cavity (not shown) is defined within sheath 42. When sheath 42 is moved to the second position, sheath 42 is sufficiently distanced from the actuator buttons 14 (shown in FIG. 2) to enable an operator to actuate transmitter 10. The second position, in one embodiment, is such that sheath 42 maintains contact with housing 12. In an alternative embodiment, the second position is such that sheath 42 is removed from housing 12 and no longer contacts housing 12.

In an alternative embodiment, sides 48 and 50 do not include locking mechanism 54. Instead, a locking mechanism (not shown) is included on front 44. The front locking mechanism interfits with housing 12 to maintain sheath 42 secured to housing 12 in the first position. In an alternative embodiment, the locking mechanism is included with housing 12 and interfits with a mating member included on sheath 42.

FIG. 4 illustrates another alternative transmitter assembly 70 including a transmitter, such as transmitter 10 (shown in FIG. 1) and a covering apparatus, e.g., a sheath, 72 that includes a bottom portion 74 and a top portion 76. Elements shown in FIG. 4 that are identical to elements shown in FIG. 1 utilize the same reference numerals used in FIG. 1. Bottom portion 74 includes a front 78, a back 80, a pair of sides 82, 84, and a bottom 86. Top portion 76 includes a connecting portion 88. Bottom portion 74 is connected to top portion 76 at back 80 and connecting portion 88 such that a cavity 90 is formed when bottom portion 74 contacts top portion 76. Sheath 72 is configured such that transmitter 10 can be positioned at least partially within, and at least partially contained by, sheath cavity 90.

When sheath 72 is in the first position, a user is unable to actuate transmitter buttons disposed on transmitter 10 when transmitter 10 is positioned within sheath cavity 90. Sheath 72 is also configured to be positioned in a second position in which bottom portion 74 does not contact top portion 76. In the second position, although transmitter is positioned within sheath cavity 90, a user is able to actuate transmitter buttons disposed on transmitter 10. In a further embodiment, one of housing 12 and sheath 22 include a seal (not shown) that facilitates the prevention of liquids from contacting actuator button 14 when sheath 22 is in the first, closed position. The seal is fabricated from a suitable sealing material as is well known in the art.

In the embodiment shown in FIG. 4, bottom portion 74 and top portion 76 are unitary and are hingedly coupled, such as with a living hinge. In an alternative embodiment, bottom portion 74 and top portion 76 are separate and distinct and are coupled to each other at back 80 and connecting portion 88, for example by a pinned hinge. In a further embodiment, sheath 72 includes a biasing member that biases top portion 76 into contact with bottom portion 74. The biasing member is connected to bottom portion back 80. Alternatively, the biasing member is connected to connecting portion 88.

Top portion 76 is, in the exemplary embodiment, shorter than bottom portion 74. Due to the length difference, a lower portion of housing 12 extends beyond top portion 76 when top portion 76 is closed with respect to bottom portion 74. The extension of the lower portion of housing 12 beyond top portion 76 enables a user to place transmitter assembly 70 on a key fob utilizing aperture 1 6, even when sheath 72 is closed. Alternatively, top portion 76 is sized similarly to bottom portion 74 such that top portion 76 substantially matches bottom portion 74. In this embodiment, a locking mechanism (not shown) is included on front 78 of bottom portion 74 and on a front of top portion 76 to lock sheath 72 in the closed position.

The above-described transmitter assemblies are cost-effective and highly reliable to prevent and/or reduce the frequency of inadvertent activation of the transmitter. The transmitter assembly includes a covering apparatus that facilitates shielding the transmitter activation buttons from being depressed. As a result, the transmitter assembly facilitates preventing inadvertent transmission of the remote transmitter in a cost-effective and reliable manner.

While the invention has been described in terms of various specific embodiments, those skilled in the art will recognize that the invention can be practiced with modification within the spirit and scope of the claims.

1. A transmitter assembly comprising:
a transmitter for remote activation of a receiver, said transmitter comprising at least one actuator;
a sheath configured to facilitate non-actuation of the transmitter; and
a closing mechanism connected to at least one of said sheath and said transmitter, said closing mechanism configured to maintain said sheath adjacent said at least one actuator when said closing mechanism is activated.

2. A transmitter assembly in accordance with claim 1 wherein said transmitter comprises a remote keyless entry transmitter.

3. A transmitter assembly in accordance with claim 1 wherein said transmitter comprises a garage door transmitter.

4. A transmitter assembly in accordance with claim 1 wherein said sheath is movable between a first position and a second position, said first position facilitates non-actuation of said transmitter, said second position facilitates actuation of said transmitter.

5. A transmitter assembly in accordance with claim 4 wherein said closing mechanism is configured to maintain said sheath in said first position, at least one of said sheath and said transmitter comprising a seal.

6. A transmitter assembly in accordance with claim 4 wherein said closing mechanism comprises a biasing mechanism configured to maintain said sheath in said second position.

7. A transmitter assembly in accordance with claim 4 wherein said closing mechanism comprises a biasing mechanism configured to maintain said sheath in said first position.

8. A transmitter assembly in accordance with claim 1 wherein said sheath is coupled to said transmitter with a biasing mechanism.

9. A transmitter assembly in accordance with claim 1 wherein said sheath is hingedly coupled to said transmitter.

10. A transmitter assembly in accordance with claim 1 wherein said sheath is slideably coupled to said transmitter.

11. A transmitter assembly in accordance with claim 1 wherein said sheath is pivotably coupled to said transmitter.

12. A transmitter assembly in accordance with claim 1 wherein said sheath inner surface is configured to remain positioned between said sheath outer surface and said transmitter.

13. A transmitter assembly comprising:
a transmitter comprising at least one actuator; and
a sheath configured to control actuation of said transmitter actuator, said sheath selectably positionable between a closed position and an open position, the closed position configured to prevent actuation of said transmitter actuator.

14. A transmitter assembly in accordance with claim 13 wherein at least one of said sheath and said transmitter comprises a closing mechanism configured to maintain said sheath in the closed position with respect to said transmitter.

15. A transmitter assembly in accordance with claim 14 wherein at least one of said sheath and said transmitter comprises a biasing mechanism configured to bias said sheath to the closed position with respect to said transmitter.

16. A transmitter assembly in accordance with claim 14 wherein said sheath coupled to said transmitter by at least one of a hinge and a biasing mechanism.

17. A transmitter assembly in accordance with claim 13 wherein at least one of said sheath and said transmitter comprising a seal.

18. A sheath for use with a transmitter including at least one actuator, said sheath configured to couple to the transmitter to facilitate preventing actuation of the transmitter actuator, said sheath comprising a closing mechanism for maintaining a position of said sheath with respect to the transmitter such that an inner surface of said sheath remains adjacent the transmitter actuator, said closing mechanism selectively engageable for controlling a position of said sheath with respect to the transmitter, said sheath further comprising at least one of a hinge assembly, a biasing mechanism, and a rail assembly for coupling said sheath with the transmitter.
